(19) United States
(12) Patent Application Publication
(10) Pub. No.: US 2013/0073310 A1
(43) Pub. Date: Mar. 21, 2013

(54) MOBILE HEALTH INTERFACE

(71) Applicant: Richard AWDEH, Miami Beach, FL (US)

(72) Inventor: Richard AWDEH, Miami Beach, FL (US)

(21) Appl. No.: 13/676,496

(22) Filed: Nov. 14, 2012

Related U.S. Application Data
(60) Provisional application No. 61/689,912, filed on Jun. 15, 2012.

(51) Int. Cl. G06Q 50/22

(52) U.S. Cl. 705/2

(57) ABSTRACT

The present invention provides an interface for collaboration between patients, medical professionals and third parties. Patients, medical professionals and third parties may share information regarding medical procedures, products and services using computer- and web-based human-machine interfaces that implement a highly interactive and personalized Mobile Health Interface. The present invention allows medical professionals to obtain informed consent from patients after patient education and development of the informed consent; medical professionals and patients may also use the system to enhance patient compliance with medical instructions and enable medical professionals to track compliance. Third parties may use the system to market products and services using targeted advertisements and promotions. Medical professionals are able to screen third-party marketing activity in order to integrate third-party services and products into patient care.

### RELATED APPLICATIONS

The present application claims priority under 35 U.S.C. §119 to U.S. Provisional Patent Application No. 61/689,912.

### SUMMARY

Visiting a doctor or healthcare professional is often a daunting process. Patients often feel overwhelmed about their underlying condition, the potential risks involved with medical procedures, and staying up-to-date on their medication. Injured individuals are bombarded with medical information or liability waivers that they cannot fully appreciate in the hospital environment. Doctors find it impracticable to monitor and educate patients outside the hospital. Third-party healthcare suppliers are unable to present their products to the patients who need them the most. What has emerged is a growing need for doctors, patients, and third parties to communicate and collaborate about the process of getting and staying well.

One glaring failure in communication between patients and doctors occurs when a patient must give her informed consent. When a patient is asked to consent to a medical procedure, she is typically asked to sign a long, complicated consent form that may be difficult to appreciate in a doctor's office or hospital setting. These consent forms can frustrate patients and do not offer the education or reassurance that the forms purport to provide. Consent is informed only if it is made with the best information and reflection that the circumstances afford. When patients have access to relevant, highly-personalized information regarding their health, they can better select, prepare for, and manage the products and procedures they need to get well.

Another problem with current systems is that patients often have inadequate access to the information that they need to fully prepare for a procedure, such as information about products needed for the procedure, related medication, etc. For example, patients and doctors rarely have time to review all possible treatment and product options. Patients may have questions that seem too difficult or embarrassing to ask. Some patients even resort to impersonal materials on the internet to make serious healthcare decisions. There is a growing need for patients to have the opportunity to select among a variety of competing treatment options, while simultaneously allowing doctors to filter untrustworthy, untested, or unnecessary treatments and products.

Other problems can arise even after a patient selects and undergoes treatment. For example, some patients may forget to take their medicine on time. Other patients may forget their rehabilitation schedule or their prescribed exercise regimen. Doctors may not be able to adequately track patient compliance and ensure that patients are adhering to their prescribed instructions. It is important for both doctors and patients to stay up-to-date on post-treatment procedures and protocols.

There is also a need for suppliers of healthcare products and services to reach potential customers in a more efficient way. Currently, it is difficult for these suppliers to target specific audiences or determine who is researching their product. When suppliers are able to identify parties within their target audience, their products are typically presented in an inefficient, non-interactive manner such as pamphlets, posters, or booklets. These materials do not harness the power of today's mobile platforms and are unlikely to address all the patient's questions about a supplier's products.

Systems and methods consistent with embodiments of the present invention provide interactive tools for collaboration among patients, doctors, and third parties. A computer-based interface may provide a centralized process for these parties to register, target, plan, compare, select, prepare, track, and continue medical treatment and product options. The interface may be made available offline or online, for example, and may be accessed through any desktop or mobile device such as an iPad or smartphone.

In some embodiments, patients may create an account to obtain access to materials offered by their physician. The interface may provide patients a way to learn about the various procedures and products that address their particular malady. The interface may educate patients about these services and the known risks, and enable patients to compare competing products and select the treatment(s) that make them most comfortable. For instance, a patient could give her informed consent after observing online tutorials, viewing educational videos, or completing online “classes,” all in the comfort of her own home. Consistent with certain embodiments, doctors may filter the content, such as product options or education modules, presented to their patients. This “gating” feature may prevent patients from accessing products or services that a doctor would not or could not provide.

In some embodiments, the interface may allow patients to track their progress before and/or after treatment. For example, patients could use the interface to manage pre-surgery protocols to ensure that the patient is surgery-ready on operation day. In other embodiments, the interface may provide post-treatment services to monitor patient compliance or educate patients about post-treatment life. For instance, the interface could send push, e-mail, phone, or text notifications to the patient to take her medicine or attend a rehabilitation class. The interface may track a patient's workout progress or provide educational videos to help the patient in her recovery.

In some embodiments, the interface may enable third party healthcare suppliers, manufacturers, and retailers to reach their target audiences. The interface may allow these suppliers, manufacturers, and retailers to reach consumers with highly-interactive, personalized content or advertisements directly related to the patient's needs. For example, the interface may enable suppliers to access a database of patients undergoing a particular kind of surgery or in a certain disease category. Suppliers who specialized in that procedure, necessary post-surgery medication, or the like could specifically target that patient with their advertising efforts.

### BRIEF DESCRIPTION OF THE DRAWINGS

FIG. 1 is a block diagram illustrating a Mobile Health Interface (MHI).

FIG. 2 depicts an MHI consistent with an exemplary embodiment of the present invention, further illustrating an exemplary data model and various application modules.

FIG. 3 is an exemplary depiction of a data model of an MHI consistent with an exemplary embodiment of the present invention, illustrating the types of data stored for medical professionals and patients.

FIG. 4 is flow diagram illustrating a medical professional gating module consistent with an exemplary embodiment of the present invention.

FIG. 5 is a flow diagram illustrating a selector tool module consistent with an exemplary embodiment of the present invention.

FIG. 6 is a flow diagram illustrating a patient education and informed consent module consistent with an exemplary embodiment of the present invention.

FIG. 7 is a flow diagram illustrating a patient compliance and tracking module consistent with an exemplary embodiment of the present invention.

FIG. 8 is a flow diagram illustrating a targeted advertising module and direct couponing module consistent with an exemplary embodiment of the present invention.

### DETAILED DESCRIPTION

One embodiment in accordance with the present invention relates to a system for providing a collaboration platform for patients, medical professionals, and third-parties, the system comprising one or more hardware processors and a computer-readable medium storing instructions, wherein the instructions cause the one or more hardware processors to: facilitate patient communication including providing patient education related to a medical procedure and obtaining informed consent for the procedure from the patient via the collaboration platform; monitor patient compliance with instructions related to the procedure, using the collaboration platform; enable the patient to select an item related to the procedure from a set of items designated by a medical professional; and enable third-parties, via the collaboration platform, to present promotional materials related to the procedure or the selected item to the patient.

Another embodiment in accordance with the present invention relates to a system for providing a collaboration platform for patients, medical professionals, and third-parties, the system comprising one or more hardware processors and a computer-readable medium storing instructions, wherein the instructions cause the one or more hardware processors to: enable a medical professional to designate, via the collaboration platform, one or more services or products related to a procedure for a patient; determine, via the collaboration platform, information related to the designated services or products; present, via the collaboration platform, the determined information to the patient; and enable the patient to select at least one of the designated services or products related to the procedure.

Yet another embodiment in accordance with the present invention relates to a system for providing a collaboration platform for patients, medical professionals, and third-parties, the system comprising one or more hardware processors and a computer-readable medium storing instructions, wherein the instructions cause the one or more hardware processors to: allow a third-party to designate, via the collaboration platform, a service or product related to a medical procedure; identify one or more promotional materials related to the designated service or product; determine one or more patients associated with the medical procedure; and present, via the collaboration platform, the identified promotional materials to the determined patients.

Systems in accordance with the present invention may comprise one or more human-machine interfaces. The one or more human-machine interfaces may encompass consumer information technology devices and hardware platforms, including general purpose computers, smartphones, tablets, personal data assistants, and other wearable computing devices such as computerized glasses. A human-machine interface may be designed solely to provide features of the present invention, or may be provided as a combination of a client-side application being executed on an existing hardware platform, e.g. a general purpose computer, tablet, or smartphone. In certain embodiments, a human-machine interface is provided by a client-side application that may be downloaded onto an existing user device, e.g. a device owned by a patient, medical professional, or third party. The download may occur using standard Internet protocols, e.g. FTP or FTPS, or through an online application store. In other embodiments, the human-machine interface comprises an Internet browser-based application executed by an Internet browser. The human-machine interface may employ a variety of features to facilitate their ease of use, such as capacitive and resistive touch-sensitive screens, natural language processing, microphones, speakers, cameras, video recording, and image recognition capability. Some embodiments include tablets and smartphones having capacitive or resistive touch-sensitive screens.

A human-machine interface may provide a seamless medium in which patients, medical professionals, and/or third parties may exchange information regarding medical products and procedures, conduct informed consent, select medical products and/or services, and share promotional materials, coupons, discounts, etc. Systems in accordance with some embodiments of the present invention may principally interact with patients, medical professionals, and third parties through the one or more human-machine interfaces, for example by providing a user-friendly graphical user interface (GUI) that leverages the feature set of a particular interface.

Systems in accordance with embodiments of the present invention may further comprise a cloud storage medium comprising a database of patient, medical professional and/or third party data. In certain embodiments, the cloud storage medium may further synchronize data between multiple interfaces to provide real-time updates between patients, medical professionals, and third parties. Synchronized data may then be used by a client-side application running on the interface to provide alerts or other guidance. For example, a patient's failure to take a critical medication at a particular time may be recorded by a interface used by the patient. The cloud storage medium may then synchronize data on the interface used by the patient including the recorded lapse with the database; the cloud storage medium may then synchronize the data on an interface used by a medical professional treating the patient in order to provide an alert to the medical professional. As implied by the foregoing example, in some embodiments the cloud storage medium may provide a decentralized data model that enhances both data accuracy and redundancy, while still maintaining data concurrency. The cloud storage medium may employ security protocols to ensure that private data is not synchronized or otherwise shared with other unintended users.

### Mobile Health Interface

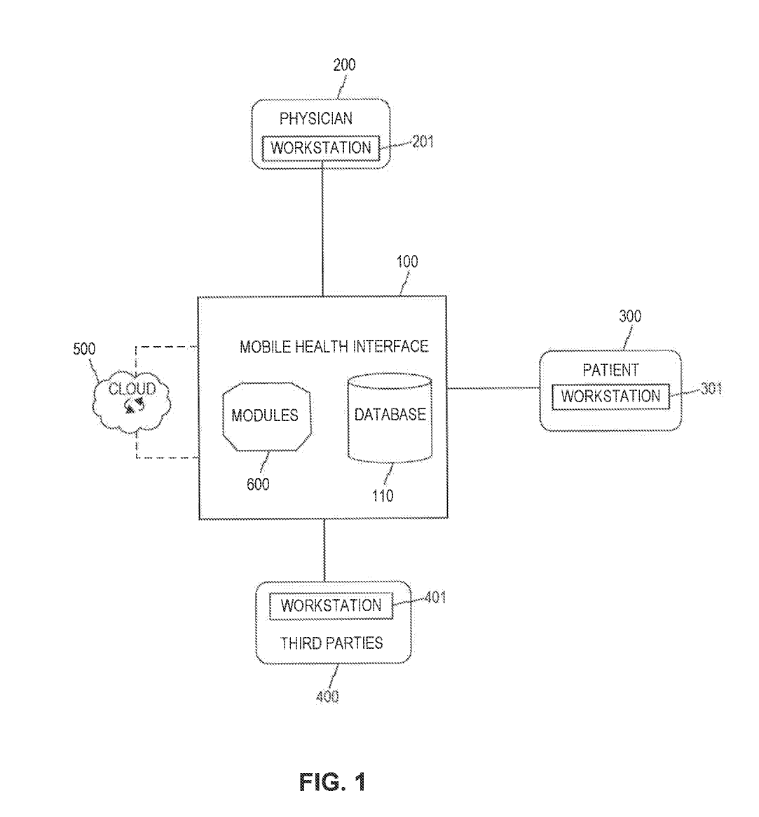

FIG. 1 is a block diagram illustrating a Mobile Health Interface (MHI) 100. As shown in FIG. 1, a MHI 100 provides an interface between a medical professional (e.g. a physician) 200, a patient 300, and a third party 400. Medical professionals 200 may include, for example, medical doctors (including osteopathic doctors), nurses, optometrists, chiropractors, and other individuals or associations of individuals involved in the treatment of patients. Third parties 400 may include, for example, healthcare suppliers, providers, manufacturers, retailers, clinics, and pharmaceutical companies. The MHI 100 comprises a computer-implemented database 110 and various application modules 600 that provide data storage and algorithms that implement features of the MHI 100. In certain embodiments, the MHI 100 is implemented in a server cloud 500 having both application and data being executed and/or stored in the server cloud 500. The server cloud 500 is one embodiment of the cloud storage medium. Physicians 200, patients 300, and third parties 400 interact with the MHI via respective human-machine interface workstations, 201, 301, and 401. Workstatations 201, 301, and 401 may be embodied by, for example, general purpose computers configured by compute readable instructions, tablets, smartphones, mobile phones, personal digital assistants, and other computing devices including wearable computing devices such as computerized glasses and/or goggles. Though shown as separate in FIG. 1, these workstations may also be the same in cases where a common workstation is used.

In some embodiments of the MHI 100, patients 300, medical professionals 200, and third parties 400 may obtain user accounts on the MHI and provide personal information that the MHI 100 may use to customize their user experience. For example, a medical professional 200 may be asked for their practice location(s); using this information the MHI 100 can better provide information regarding nearby services. Likewise, a patient 300 supplying his home address may be shown a listing of nearby medical professionals 200 and third parties 400 in order to more conveniently obtain healthcare services and/or products. Third parties 400 may view the locations of patients 300, medical professionals 200, and other third parties 400 to focus their marketing activity. Patients 300, medical professionals 200, and third parties 400 may independently obtain accounts, or may be invited to do so by those with existing accounts. For example, a medical professional 200 may provide a code to a patient 100; the patient 100 may then use this code to obtain an account which may be have already been customized with information regarding the medical professional 200.

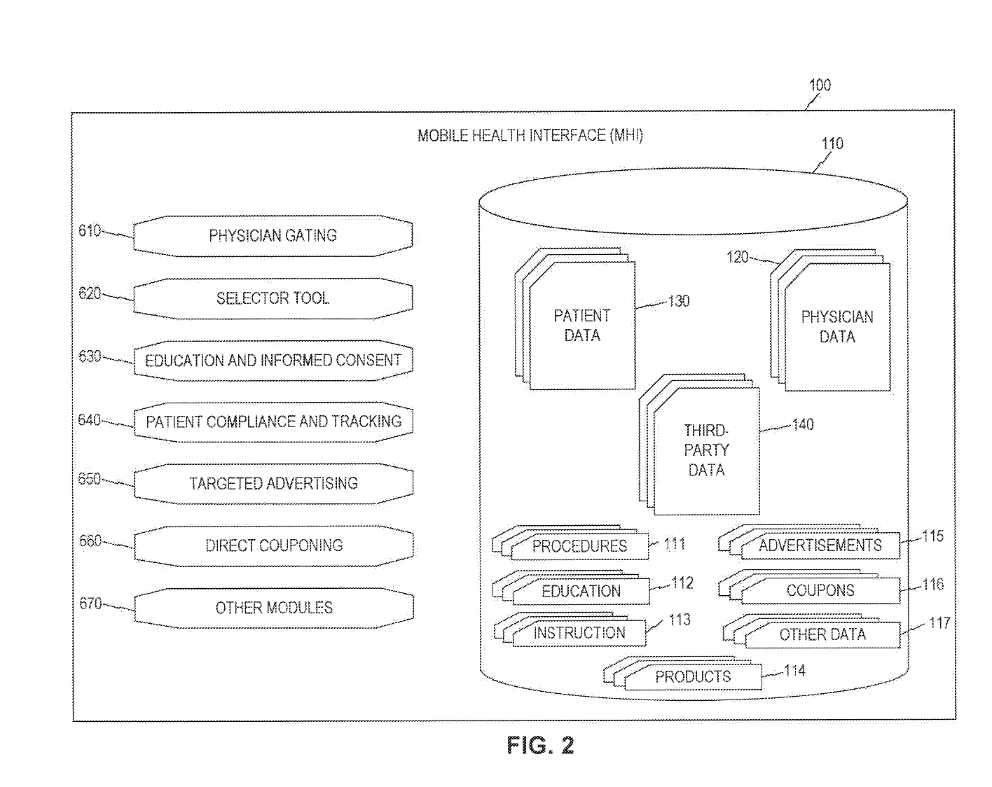

FIG. 2 depicts an MHI 100 consistent with an exemplary embodiment of the present invention, further illustrating an exemplary data model and various application modules. As shown, FIG. 2, the MHI 100 may comprise a database 110 and application modules. In certain embodiments, the MHI database 110 stores records of patients 130, physicians 120, and third parties 140. These records may correspond to the user accounts as described above. The database also stores several data elements common to the MHI 100, such as information regarding medical procedures 111, education 112, instructions 113, products 114, advertisements 115, and coupons 116, and other data 117. Data elements 111-117 may include text, image, video, or other interactive content providing information regarding the designated subject matter. For example a product data element 114 regarding a particular intraocular lens product may include an image of the lens and textual information describing its particular use, when it was introduced, its availability from third parties, and/or a range of variable parameters e.g. size, color, strength.

Data elements 111-117 may be independent, or they may be structured within the database to provide links between logically related elements. For example, information regarding a medical procedure, e.g. cataract removal, may be stored on the database as a procedure data element 111. This procedure data element 111 may be linked or associated with one or more education data elements 112 that provide information relevant to educating a patient 300 about the procedure, such as potential complications of cataract removal and average time of healing after cataract removal. The procedure data element 111 may further be linked with one or more instruction data elements 113 including information regarding preoperative and postoperative directives to the patient to prepare for the procedure and to manage postoperative care. The procedure data element 111 may be further associated or linked with one or more product data elements 114 which detail available products relevant to the procedure, such as potential replacement lenses following cataract removal and eyedrops which aid in post-operative pain management. Product data elements 114 may be linked to one or more advertising data elements 115 that provide promotional information and/or one or more coupon data elements 116 that provide discounts on the linked product. Structuring data elements in this manner can obviate the need for complex search algorithms to locate relevant data. By selecting a particular procedure data element 111, a user is easily able to see the linked data elements, e.g. the linked education 112, instruction 113, product 114, advertising 115, and coupon data elements 116.

The application modules shown in FIG. 2 may be computer readable instructions stored on a non-transitory computer readable medium (or media) that when executed by one or more processors provide various functions and interfaces of the MHI 100. The instructions may be executed on the client-side, e.g. the workstations 201, 301, 401, the server-side, e.g. the server cloud 500, or in a combination. As depicted, the application modules 600 may comprise a physician gating module 610, a selector tool module 620, an education and informed consent module 630, a patient compliance and tracking module 640, an targeted advertising module 650, and a direct couponing module 660, and other modules 670. Examples of these modules are described in more detail below.

### Physician Gating Module

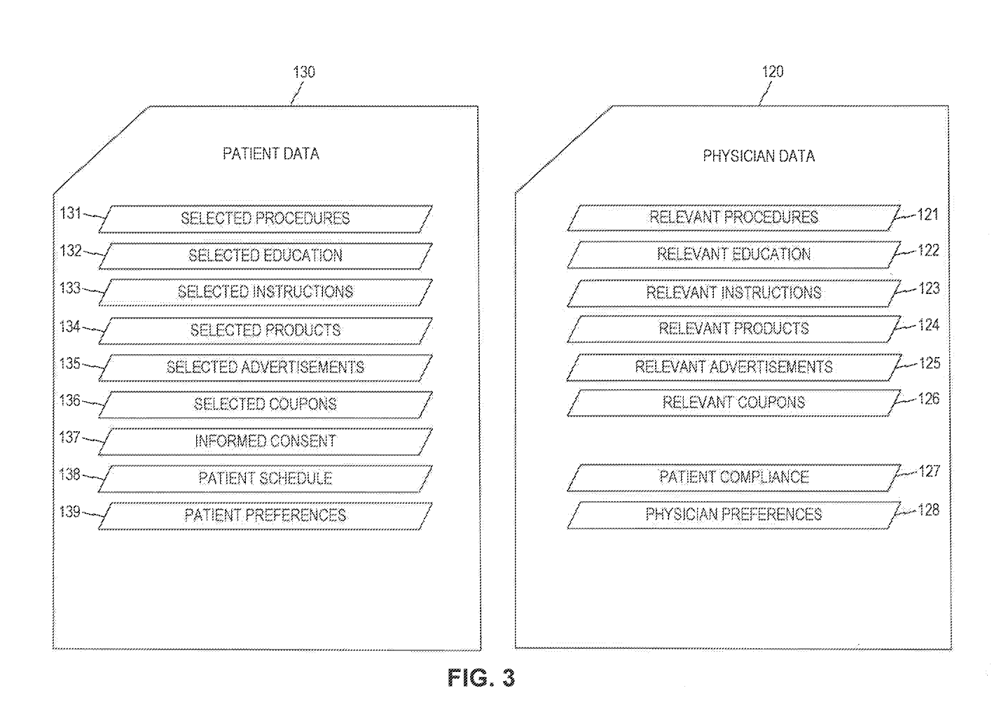

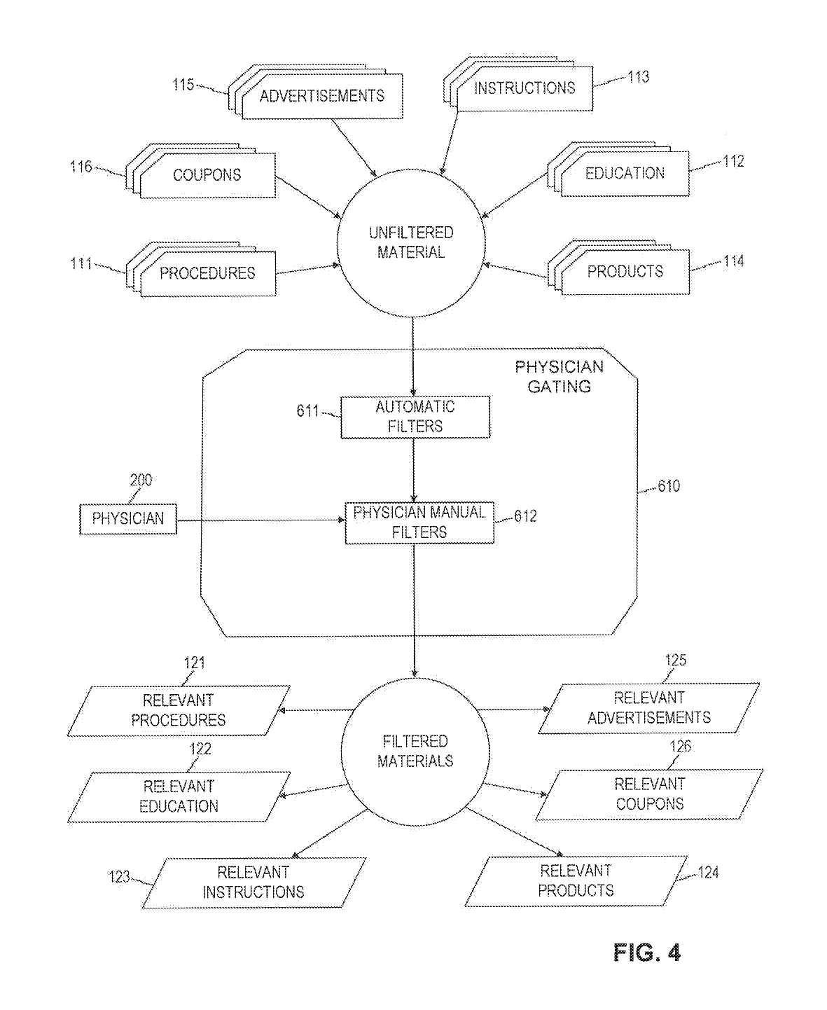

FIG. 4 is flow diagram illustrating a physician gating module 610 consistent with an exemplary embodiment of the present invention. The physician gating module 610 allows a medical professional to heuristically filter information regarding procedures, products, patient education, patient instructions, advertisements, and coupons to those which are both relevant to either the medical professional 200, a patient 300, or both. For example, the procedure data elements 111 stored in the database of the MHI may include information on a multitude of medical procedures, e.g. cataract removal, colonoscopies, dialysis, etc. However, for a given medical professional 200, e.g. an ophthalmologist, many of these procedures will be irrelevant to their practice. The physician gating module 610 facilitates selection of the subset of the data elements stored on the MHI database 110 which are relevant to the medical professional 200. As shown in FIG. 3, these relevant data elements may be referenced or stored in the physician records 120 of the MHI database 110. Such physician records 120 may be associated with particular medical professionals via e.g. the user accounts previously discussed.

The physician gating module 610 may receive unfiltered material comprising the data elements common to the MHI 100, such as data elements comprising information regarding medical procedures 111, education 112, instructions 113, products 114, advertisements 115, and coupons 116. From these unfiltered materials, the physician gating module 610 may apply an automatic filter 611 to yield an initial set of relevant data elements. The automatic filter 611 may consider such information as the medical professional's 200 practice, certifications, location, access to particular facilities and/or equipment, patient census, as well as heuristic information regarding the medical professional 200 including procedures performed and previously prescribed medicines and therapies. This automatic filter 611 may also consider the medical professional's 200 preferences 128 regarding what advertisements are relevant to his or her practice and his or her patients. The initial set of filtered data elements is then optionally provided to the medical professional 200 for manual filtering 612, so that the medical professional may further add or remove particular data elements. For example, a particular ophthalmologist may categorically prefer a premium lens over a generic lens based on his experience with patient outcomes. The manual filter 612 gives the ophthalmologist the option of removing data elements regarding the generic lens from the set of his or her relevant data elements. The physician gating module 610 thereby outputs a set of filtered materials which comprise relevant procedures 121, relevant patient education 122, relevant patient instructions 123, relevant products 124, relevant advertisements 125, and relevant coupons 126. These relevant materials may then be stored on the medical professional's record 120 in the MHI database 110.

### Selector Tool Module

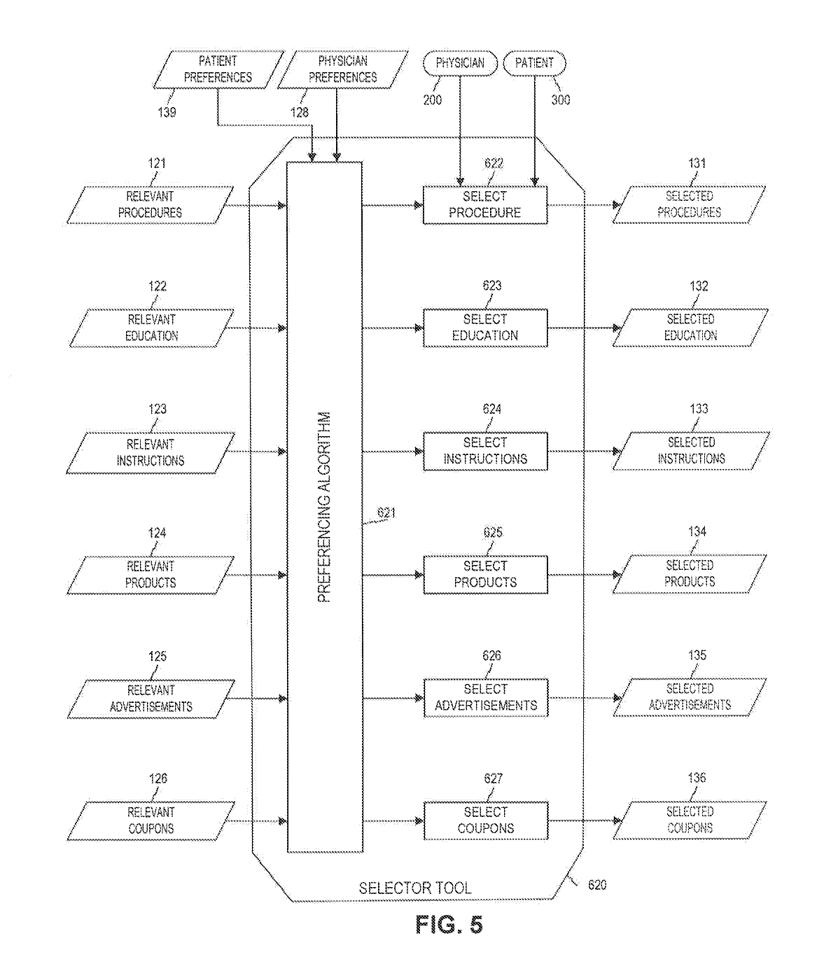

FIG. 5 is a flow diagram illustrating a selector tool module 620 consistent with an exemplary embodiment of the present invention. In certain embodiments, the selector tool module 620 applies an additional set of filters to the relevant data elements 121 to 126, yielding a set of selected data elements 131-136 which are particularly tailored to a patient 300 and a medical professional 200 treating the patient. In this manner, the medical professional 200 is able to provide personalized information to the patient based on interactions between the parties, to obtain informed consent to elected procedures, and to track patient compliance with preoperative, perioperative, and postoperative instructions. The selected data elements may be stored, for example, in a patient record 130 in the MHI database 110, as shown in FIG. 3. The patient record 130 may be associated with a user account as previously discussed.

The selector tool module 620 allows a medical professional 200 and a patient 300 to select from the relevant data elements yielded by the physician gating module 610 those data elements which are of concern to both the medical professional 200 and the patient 300. For example, during a meeting with her physician 200, a patient 300 might be presented with multiple procedures capable of treating her condition. As part of the selector tool module 620, the physician 200 may then use the MHI 100 to select the procedure data elements that contain information about the discussed procedures and provide those selected procedure data elements 131 to the patient 300. The physician 200 may also choose to provide educational materials to the patient by selecting the corresponding education data elements 132. For her part, the patient 300 may review these materials in order to become more familiar with her condition and to review treatment options. Further interaction between the patient 300 and physician 200 may result in pursuing a particular procedure as a part of a treatment; the physician may then provide the patient with a selected procedure data element 131 corresponding to the particular procedure and additional selected education data elements 132 in order to educate the patient and develop informed consent.

The selector tool module 620 may receive relevant procedures 121, relevant patient education 122, relevant patient instructions 123, relevant products 124, relevant advertisements 125, and/or relevant coupons 126 which have been filtered by the medical professional from the procedures 111, patient education 112, patient instructions 113, products 114, advertisements 115, and coupons 116 stored on the MHI database 110. The selector tool module 620 may then apply both the medical professional's selection and preferences 128 regarding the relevant data elements 121-126 and the patient's selection and preferences 139 regarding the relevant data elements 121-126 to yield a set of a selected data elements which comprise selected procedures 131, selected patient education 132, selected patient instructions 133, selected products 134, selected advertisements 135, and selected coupons 136.

As indicated above, the selector tool module 620 may apply patient preferences 139 and medical professional preferences 128 in determining the selected data elements and/or aiding selection by the patient 300 and medical professional 200. For example, a patient 300 may prefer to view no advertisements, or may desire to view advertisements related to their current selected products, or may desire to view advertisements from a particular third party 400. A medical professional 200 on the other hand may choose to provide advertisements from other third parties 400 or may restrict the same. The selector tool module 620 may apply these preferences by using a preferencing algorithm 621, for example, by assigning different weights to the preferences, or giving precedence to certain preferences over others, or excluding some preferences. An outcome of the preferencing algorithm 621 may be that there are no advertisements in cases where the patient 300 has elected to view no advertisements, or a restricted set of advertisements based additionally on the medical professional's 200 preferences 128. The preferencing algorithm 621 may also rely on analytical data gathered by other modules of the MHI 100. Additionally, the preferencing algorithm 621 may suggest selections to either the patient 300 or the medical professional 200.

### Education and Informed Consent Module

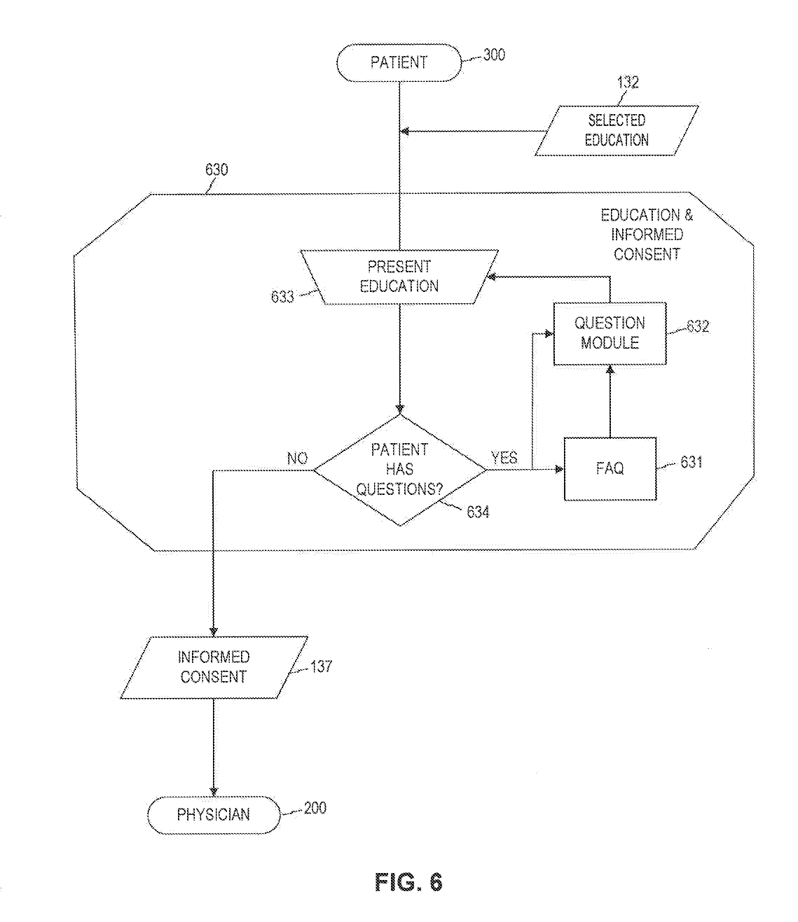

FIG. 6 is a flow diagram illustrating a patient education and informed consent module 630 consistent with an exemplary embodiment of the present invention. The education and informed consent module 630 is an exemplary implementation of a feature of the present invention: obtaining informed consent from a patient after development of the informed consent and appropriate patient risk education. One significant benefit of systems in accordance with embodiments of the present invention, including the MHI 100, is that patients may review educational materials using a human-machine interface workstation from the comfort of their own home, thus preventing situations where informed consent may be tainted by concerns of pressure and the need to consider excessive information under the circumstances.

As shown in FIG. 6, in certain embodiments the education and informed consent module 630 presents selected education data elements 132 to a patient 300 taking as input the selected education data elements 132 (shown in 633). The selected education data elements 132 may provide educational information regarding one or more medical procedures. This educational information may be presented in an interactive format and may comprise a variety of multimedia and interactive formats. For example, the patient 300 may be able to view videos of the procedure and participate in short “quizzes” that verify the patient's 300 understanding of a particular aspect of the procedure. The selected education data elements 132 may include online tutorials, educational videos, or online “classes.” The selected education data elements 132 may also provide information on the patient's 300 diagnosis and treatment options, including available procedures and products. The selected education elements 132 may be selected by a physician 300.

The education and informed consent module 630 queries whether the patient 300 has questions after being presented with the information in the selected education data element 132 (shown in 634). If the patient 300 has questions, the module 630 directs the patient 300 to a set of frequently asked questions and answers (FAQs) 631 and/or to a question module 632. Both the set of FAQs 631 and the question module 632 may be presented the patient 300; alternatively, the module 630 may determine which is more appropriate by, for example, parsing a patient's 200 question using natural language processing algorithms and determining if the question (and its answer) resides in the FAQs 631. The question module 632 allows the patient 300 to pose questions regarding the information contained the selected education data elements 132 to a medical professional 200 treating the patient 300. In some embodiments, the question module 632 may allow the patient to send an e-mail to or call the medical professional 200. In some embodiments, the patient 300 uses the question module 632 on his or her workstation 301 to send a message to the workstation 201 of the medical professional 200. The workstation 201 may then alert the medical professional 200 that the patient 300 has asked a question and provide an opportunity to the medical professional 200 to provide an answer. An answer may then be sent back to the patient 300, whose workstation 301 may then provide an alert indicating the presence of an answer. The messages sent using the question module 632 may be archived on the MHI database 110.

If the patent 300 continues to have questions, the education and informed consent module 630 may continue to present the selected education data elements 132 and directing the patient 300 to the FAQs 631 and/or the question module 632. Once the education and informed consent module 630 determines that the patient 300 no longer has questions regarding the information in a selected data education element 132, e.g by using a direct query dialog using a GUI on the patient's human-machine interface workstation 301, it provides an opportunity for the patient 200 to provide informed consent 137 and can transmit the informed consent 137 to the medical professional 200.

An additional aspect of the education and informed consent module 630 is the tracking of the patient's 300 progress and the development of informed consent. For example, the module may track which educational materials have been viewed and for how long so that a medical professional 200 can determine if a patient 300 is obtaining information critical to giving informed consent 137.

### Patient Compliance and Tracking

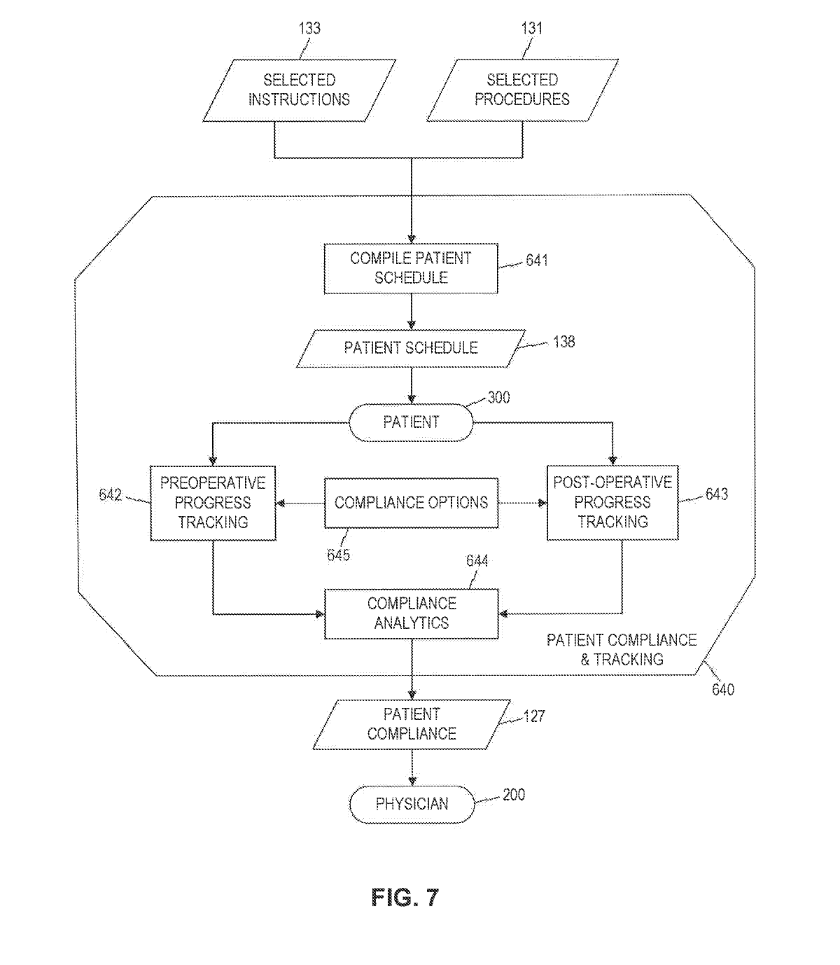

FIG. 7 is a flow diagram illustrating a patient compliance and tracking module 640 consistent with an exemplary embodiment of the present invention. As discussed, embodiments of the present invention allow patients 300 and medical professionals 200 to manage preoperative, perioperative, and postoperative care by tracking patient compliance with medical instructions and providing appropriate reminders. The patient compliance and tracking module 640 of the MHI 100 is an exemplary implementation of this feature.

As an initial step, the patient compliance and tracking module 640 compiles 641 a patient schedule 138 based on a set of selected instructions (e.g. selected instruction data elements 133) and selected procedures (e.g. selected procedure data elements 131). In one embodiment, this initial step automatically occurs when the patient gives informed consent 127 from the education and informed consent module 630. In other embodiments, a medical professional 200 may review the informed consent 127 and authorize the action of the patient compliance and tracking module 640. The patient schedule 138 may be generally described as a set of preoperative, perioperative, and/or postoperative care instructions. Schedule 138 may include a timeline of events, for example a schedule comprising a medication schedule indicating what medications need to be taken and when, a schedule of weekly follow-up appointments with a medical professional 200 treating the patient 300, a physical therapy regimen, etc. The patient compliance and tracking module 640 may present the schedule 138 to the patient 300 via his or her workstation 301 in an easy-to-understand and user-friendly format such as a calendar or an interactive timeline.

In addition, the patient compliance and tracking module 640 includes interactive components 642 and 643 that track the patient's compliance with preoperative and postoperative instructions. The interactive components allow the patient 300 to indicate that she has complied with an instruction and can also alert the patient 300 to upcoming instructions, e.g. reminding the patient 300 to take particular medication at a specified time. Such reminders may be provided via the patient's workstation 301, or through means including e-mail, text, and push messages (these messages may also be received on the workstation 301). Compliance options 645 may be used to control the types and level of alerts and reminders. The compliance options 645 may specify, for example, that certain reminders and/or alerts, e.g. reminders and/or alerts regarding when to take a particular medication, are to be given to a patient 300, but others, e.g. reminders and/or alerts regarding an upcoming appointment with an in-home physical therapist, are not. A patient 300 and a physician 200 may specify via the compliance options 645 a desire to receive no alerts and/or reminders while still taking advantage of the schedule 138 and its user-friendly presentation. Compliance options 645 may also increase or decrease the frequency, intrusiveness, and/or type of reminder and/or alert provided; the provided alert and/or reminder may be provided in certain forms, e.g. a visual indicator, but not others, e.g. a repetitive noise that draws attention. The patient's 300 response to the interactive components 642 and 643 indicating compliance or lack thereof is analyzed by the module to determine compliance analytics 644 and the results (patient compliance 127) may be provided to the medical professional 200. Patient compliance 127 obtained from such analysis may include statistical information on compliance, for example the average number of missed medications per week.

By way of example, a patient 300 may be told by a medical professional 200 to fast the day before a surgery in order to prevent complications with anesthesia. Additionally, on the day of surgery and for the following two days, the medical professional 200 may prohibit the patient 300 from driving. The medical professional 200 may also prescribe several medications that have different dosing regimens (twice daily, once every other day, etc.). These instructions may be encoded into instruction data elements 113 stored in the MHI database 110 and provided as selected instruction data elements 133 to the patient 300. Following the patient's informed consent 127, the patient compliance and tracking module 640 compiles a patient schedule 138 from the selected instruction data elements 133. The preoperative and perioperative instructions, e.g. fasting and driving prohibitions, may be presented the patient 300 through a GUI executed on the patient's workstation 301; the patient 300 may then be asked to indicate whether or not they have complied with the preoperative and perioperative instructions. Following surgery, the patient compliance and tracking module 640 may similarly present the patient 300 with a schedule 138 of when to take their medications and inquire whether the patient 300 complied with the schedule 138. If the patient 300 misses a drug dose, the patient compliance and tracking module 640 may then provide an alert to the patient 300 using the patient's workstation 301 reminding them to do so. The patient's 300 adherence to this schedule is analyzed and provided to the medical professional 200 in order to help manage the patient's 300 postoperative care.

### Targeted Advertising and Direct Couponing

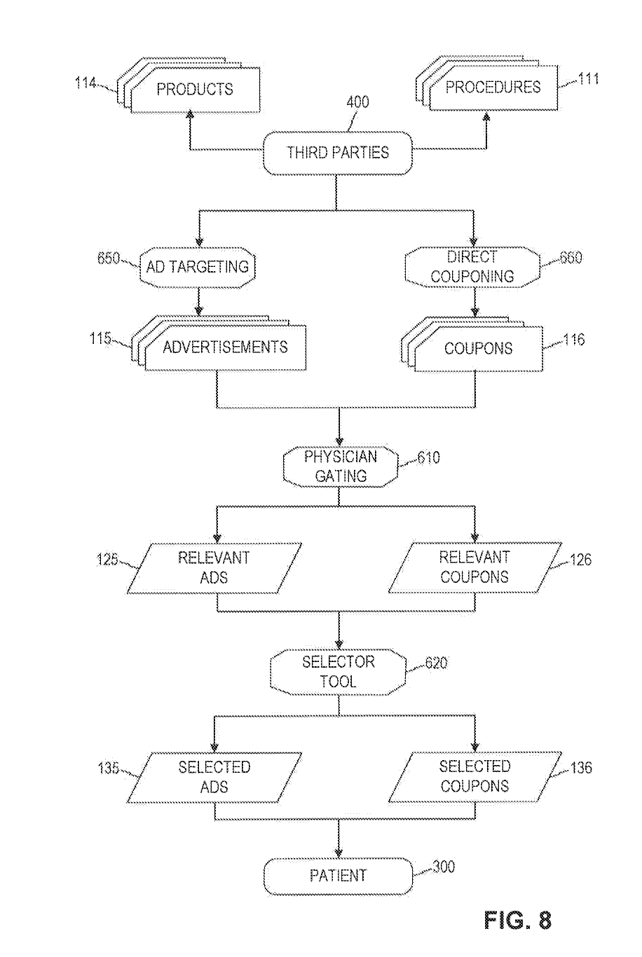

FIG. 8 is a flow diagram illustrating a targeted advertising module 650 and direct couponing module 660 consistent with an exemplary embodiment of the present invention. Embodiments of the present invention allow third parties 400 to market their products and/or services to patients via targeted advertising and promotions, e.g. promotional coupons. In some embodiments, medical professionals may specify the level of marketing by screening and filtering promotional materials prior to their being viewed by patients.

Third parties 400 may include a variety of health-related enterprises. Non-limiting examples include healthcare suppliers, providers, manufacturers, retailers, clinics, and pharmaceutical companies. Third parties 400 may supply products such as medicinal agents (e.g. prescription and over-the-counter drugs, topical lotions, unguents, eye drops, etc.) and medical devices (e.g. orthotic inserts, walking aids, wheelchairs, joint braces, vision and hearing aids, prosthetics, cosmetic aids, wound protectants, etc.). They may also supply services such as in-home nursing care and physical therapy. Medical professionals 200 that are not currently treating a particular patient 300 may also be third parties 400 for the purpose of specialty or second opinions.

As shown in FIG. 8, third parties 400 may view product 114 and procedure 111 data elements present in the MHI database 110. These data elements may include analytical information such as frequency of use, level of prescription, and quantitative and qualitative feedback measures from patients 300 and medical professionals 200. This information may be collected by the MHI 100 through various means, such as through the interactive component of the patient compliance and tracking module 640, e.g. through preoperative 642 and postoperative 643 tracking. Based on this information, third parties 400 may provide promotional materials including advertisements and coupons directed at patients undergoing a particular procedure or using a certain product. These materials may be encoded or formatted into advertising data elements 115 and coupon data elements 116. Accordingly, the MHI 100 allows third parties 400 to target their marketing activity based on information relating to how their products and/or services are used by patients 300 and medical professionals 200. These promotional materials may be interactive, using the human-machine interface capabilities of a workstation, e.g. workstations 201, 301 and 401 to present a compelling narrative, or to let patient 300 explore educational materials regarding the efficacy of a particular product or service. These promotional materials may be linked in MHI database 110 with their corresponding services and/or products, e.g. as advertisement and coupon

Importantly, medical professionals 200 and patients 300 may specify the level of marketing. As discussed above, an exemplary embodiment of this feature may be implemented using the physician gating module 610 and the selector tool module 620. These modules limit the scope of promotional activity by allowing the medical professional 200 to determine which promotional materials are relevant, and further by allowing both medical professionals 200 and patients 300 to select promotional materials based specifically on their particular needs and preferences.

What is claimed is:

1. A system for providing a collaboration platform for patients, medical professionals, and third-parties, the system comprising one or more hardware processors and a computer-readable medium storing instructions, wherein the instructions cause the one or more hardware processors to:
facilitate patient communication including providing patient education related to a medical procedure and obtaining informed consent for the procedure from the patient via the collaboration platform;
monitor patient compliance with instructions related to the procedure, using the collaboration platform;
enable the patient to select an item related to the procedure from a set of items designated by a medical professional; and
enable third-parties, via the collaboration platform, to present promotional materials related to the procedure or the selected item to the patient.

2. The system of claim 1, wherein the instructions are one of preoperative instructions, postoperative instructions, and perioperative instructions.

3. The system of claim 1, wherein the instructions relate to one of a medication or a physical act prescribed by the medical professional.

4. The system of claim 1, wherein the monitoring of patient compliance further includes sending a reminder to the patient regarding the instructions.

5. The system of claim 1, wherein the promotional materials include one or more of an advertisement, a coupon, and a marketing material.

6. The system of claim 1, further comprising one or more human-machine interfaces comprising a graphical user interface.

7. The system of claim 6, wherein the one or more human-machine interfaces comprises a tablet computer or smartphone having a touch-sensitive screen.

8. The system of claim 7, further comprising a cloud storage medium that synchronizes data between a central database storing information for patients, medical professionals, and third-parties, and the one or more human-machine interfaces.

9. A system for providing a collaboration platform for patients, medical professionals, and third-parties, the system comprising one or more hardware processors and a computer-readable medium storing instructions, wherein the instructions cause the one or more hardware processors to:
enable a medical professional to designate, via the collaboration platform, one or more services or products related to a procedure for a patient;
determine, via the collaboration platform, information related to the designated services or products;
present, via the collaboration platform, the determined information to the patient; and
enable the patient to select at least one of the designated services or products related to the procedure.

10. The system of claim 9, wherein the instructions further cause the hardware processors to:
enable a third-party provider of a selected product or service to present a related promotional material to the patient, wherein the promotional material is at least one of an advertisement, a coupon, and a marketing material.

11. The system of claim 9, wherein the promotional materials include one or more of an advertisement, a coupon, and a marketing material.

12. The system of claim 9, further comprising one or more human-machine interfaces comprising a graphical user interface.

13. The system of claim 12, wherein the one or more human-machine interfaces comprises a tablet computer or smartphone having a touch-sensitive screen.

14. The system of claim 13, further comprising a cloud storage medium that synchronizes data between a central database storing information for patients, medical professionals, and third-parties, and the one or more human-machine interfaces.

15. A system for providing a collaboration platform for patients, medical professionals, and third-parties, the system comprising one or more hardware processors and a computer-readable medium storing instructions, wherein the instructions cause the one or more hardware processors to:
allow a third-party to designate, via the collaboration platform, a service or product related to a medical procedure;
identify one or more promotional materials related to the designated service or product;
determine one or more patients associated with the medical procedure; and
present, via the collaboration platform, the identified promotional materials to the determined patients.

16. The system of claim 15, wherein the one or more patients are determined based on at least one of:
usage, by the one or more patients, of the designated service or product;
recommendation of the medical procedure to the one or more patients, by a medical professional; and
undergoing the medical procedure by the patient.

17. The system of claim 15, wherein the promotional materials include one or more of an advertisement, a coupon, and a marketing material.

18. The system of claim 15, wherein the instructions further cause the one or more hardware processors to:
enable a medical professional to screen the promotional materials prior to presentation of the promotional materials to the patients.

19. The system of claim 15, further comprising one or more human-machine interfaces comprising a graphical user interface.

20. The system of claim 19, wherein the one or more human-machine interfaces comprises a tablet computer or smartphone having a touch-sensitive screen.

21. The system of claim 20, further comprising a cloud storage medium that synchronizes data between a central database storing information for patients, medical professionals, and third-parties, and the one or more human-machine interfaces.
